(19) United States
(12) Patent Application Publication
(10) Pub. No.: US 2002/0149336 A1
(43) Pub. Date: Oct. 17, 2002

(54) Method and system for improving efficiency of rotating, synchronous, electrical machine interacting with power converter

(76) Inventor: Roman Bida, Derry, NH (US)

Correspondence Address: ROMAN BIDA, 14 NUTMEADOW LN, DERRY, NH, 03038, US

(21) Appl. No.: 09/833,982

(22) Filed: Apr. 13, 2001

(51) Int. Cl. H02P 1/46; H02P 3/18; H02P 5/28; H02P 7/36

(52) U.S. Cl. 318/700

(57) ABSTRACT

Disclosed is a method of maximizing the system efficiency in the system comprising of a synchronous electrical machine (motor or generator) and a power converter. Furthermore, it discloses a system comprising of an electrical machine (motor or generator), a power converter, and a power converter's controller employing the disclosed method. In the disclosed invention, the power converter introduces a spectrum of harmonic components increasing the utilization of the torque creation capability of the electric machine acting as a motor, or current creation capabilities of the machine acting as a generator, and improving efficiency of the torque/current creating process. Consequently, the system efficiency is substantially improved, and the system reaches the performance level of the more sophisticated, therefore more complicated, and less cost-effective solutions. The disclosed single-phase embodiment of the invention offers further improvement of the cost-performance characteristics of the machine/converter system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to the power systems comprising of an electrical machine and a power converter interacting with the machine. In particular, it relates to a method and systems that improve the efficiency of the system employing a synchronous, rotating electrical machine by compensating characteristics of the said electrical machine with additional harmonics generated by the power converter.

Rotating electrical machines (motors or generators) employ a number of sources of the magnetic field generating time-variable fields. Interaction among the magnetic fields generates the torque, which in the frequency domain contains the time invariable component and a range of time dependent components (torque ripple). For the purpose of the machine analysis, the time-variable magnetic field can be broken down, by using the Fourier transformation, into a number of sinusoidal components - harmonics. The interactions between the fields' harmonics generate torque harmonics (ripple). The torque ripple and harmonics in the rotating electrical machine often reduce machine efficiency, increase mechanical vibrations, increase noise, and when transferred to the shaft, interfere with the load or the prime mover, such as a turbine or an engine.

The following factors typically contribute to the reduction of the system efficiency:

Mechanical/magnetic design of the electrical machine, and especially the distribution of the magnetic field in the air gap and the winding inductance

Characteristics of the power converter, and in particular, the spectrum of the converter supplied harmonics and the type of harmonics (current, voltage)

Dynamic interaction between the power converter and the electrical machine, primarily the type of the employed control and the presence of the reactive components in the system (inductors, capacitors, filters)

The mechanical design of an electrical machine substantially influences the content of the harmonics in the system. The distribution of the magnetic field in the air gap may be modified to accommodate particular design goals. An example of the permanent magnet motor with a substantially reduced presence of harmonics in the back-EMF is disclosed in U.S. Pat. No. 4,629,916. A number of small brushless motors that balance performance with motor complexity and the manufacturing cost are disclosed, for example, in U.S. Pat. No. 4,804,873 or in U.S. Pat. No. 4,730,136.

Characteristics of the power converter, and especially the type and spectrum of harmonics introduced by the power converter and the type of employed control do influence the harmonics content and the system performance. The most typical power converters, control methods and electrical machine/converter systems are presented by N. Mohan, T. Underland and W. Robbins in “Power Electronics, Converters, Applications and Design” published by John Wiley and Sons, Inc. in 1995; by Andrzej M. Trzynadlowski in “The Field Orientation Principle in Control of Induction Motors” published in 1994 by Kluwer Academic Publishers; by Henryk Tunia and Marian Kazmierkowski in “Automatyka Napedu Przeksztaltnikowego” published by Panstwowe Wydawnictwo Naukowe in 1987, and by Werner Leonhard in “Control of Electrical Drives” published by SpringerVerlag in 1996.

For permanent magnet based synchronous machines there are three basic machine/converter configurations characterized in terms of the voltage applied to the synchronous machine: six-step (square wave), trapezoidal, and sinusoidal. The six-step (square wave) drive system sequentially changes the voltage applied to the motor windings and generates the synchronous field required for machine operation. The switching sequence is coupled with the shaft (rotor field) position. To improve six-step system performance, the motor voltage is often added as another degree of freedom. The voltage control is achieved by either control of the inverter supplying DC voltage (double conversion), or by superimposing the PWM pattern on the six-step waveform. The pure six-step requires very low switching frequency and, in effect, inverter efficiency is high. The drawback of this method is that the machine is treated with substantially distorted currents that lead to increased power losses. The current harmonics are also responsible for the high level of machine-generated noise.

The trapezoidal drive system, although similar in principle to the six-step drive, generates trapezoidal instead of square-wave voltage waveform. The change of shape is achieved by applying a PWM-modulated-voltage transition instead of the simple switching from one polarity to another. The average voltage value forms a trapezoid. The trapezoidal system performs better than six-step in terms of efficiency and torque pulsations. For the full optimization of the trapezoidal solution, the motor requires special design.

The sinusoidal system employs PWM-modulated, sinusoidal voltages. The converter controls the voltage amplitude and frequency. This system is capable of achieving high motor efficiency and low noise, but at the expense of inverter efficiency and substantial system complexity. In this case, the motor design requires special attention, as well.

All three methods create certain level of a mismatch between the converter and the machine causing the creation of the parasitic current and torque components which degrade the system's performance. For efficiency improvement in all three cases, expensive in design and manufacturing machine must be combined with sophisticated, and often difficult to implement, control techniques.

In the general engineering practice, in addition to the selection of system topology and a type (six-step, trapezoidal, sinusoidal), the content of harmonics is modified by the use of the sophisticated design techniques for the electrical machine design. Some of the employed techniques include: selecting the optimal type and configuration of the electrical machine, shaping the back-EMF, skewing the motor slots, and increasing the winding inductance. The harmonics content may be influenced by certain power converter characteristics such as: the type of modulation, switching frequency, or the control methods employed in the controller of the power converter. The introduction of additional components (inductors or filters) to the system is also a common engineering practice, especially during the system integration phase. The above-mentioned methods of harmonics reduction in the system generally reduce system efficiency, increase the electrical machine manufacturing cost, or increase the complexity and the cost of the entire system. They also increase development cost and time to market.

### BRIEF SUMMARY OF THE INVENTION

The present invention discloses a method of maximizing the system efficiency in the system comprising of a synchronous electrical machine (motor or generator) and a power converter. Furthermore, it discloses a system comprising of an electrical machine (motor or generator), a power converter, and a power converter's controller employing the method of maximizing the system efficiency. In the disclosed invention, the power converter introduces a spectrum of harmonic components increasing the utilization of the torque creation capability of the electric machine acting as a motor, or current creation capabilities of the machine acting as a generator, and improving efficiency of the torque/current creating process.

The disclosed method by adapting converter characteristics to the sub-optimal machine design reduces the level of complexity of the electrical machine and allows reaching higher level of efficiency. By shifting the burden of performance optimization to the controller of the power converter, a simple and cost-effective motor design may be employed. The controller, in the form of the specialized integrated circuit or DSP algorithm, is in production quantities considerably less expensive than high current carrying components such as filters or inductors or sophisticated motor designs otherwise employed to achieve an improvement of the system's efficiency.

By increasing the utilization of the machine-generated harmonics in the typically low efficiency system configurations, the new level of cost-performance can be achieved. An example of such improvement is a single-phase permanent magnet synchronous motor supplied by a single-phase sinusoidal voltage source inverter, or a three-phase permanent magnet synchronous motor supplied by a single-phase sinusoidal voltage source inverter.

### BRIEF DESCRIPTION OF THE SEVERAL VIEWS OF THE DRAWING

FIG. 1. A schematic block diagram depicting the harmonics flow in the typical embodiment of the prior art system.

FIG. 2. A schematic block diagram depicting the harmonics flow in the typical embodiment of the disclosed invention.

FIG. 3. A chart presenting voltage, current, and torque waveforms as generated in the prior art sinusoidal system.

FIG. 4. A chart presenting optimized voltage, current, and torque waveforms as generated in the typical embodiment of the disclosed invention.

FIG. 5. A schematic block diagram depicting a two-phase system as disclosed in the invention.

FIG. 6. A schematic block diagram depicting details of the single-phase system as disclosed in the invention.

FIG. 7. A chart depicting the reduction of power consumption achieved by employing the disclosed method in the high-speed spindle of an enterprise-class storage device (hard disk).

FIG. 8. A chart depicting the reduction of power consumption achieved by employing the disclosed method in the system employing permanent magnet synchronous motor in the DC brushless fan.

### DETAILED DESCRIPTION OF THE INVENTION

The present invention discloses a method of maximizing the system efficiency in the system comprising of a synchronous electrical machine (motor or generator) and a power converter. Furthermore, it discloses a system comprising of an electrical machine (motor or generator), a power converter, and a power converter's controller employing the method of maximizing the system efficiency. In the disclosed invention, the power converter introduces a spectrum of harmonic components increasing the utilization of the torque creation capability of the electric machine acting as a motor, or current creation capabilities of the machine acting as a generator, and improving efficiency of the torque/current creating process.

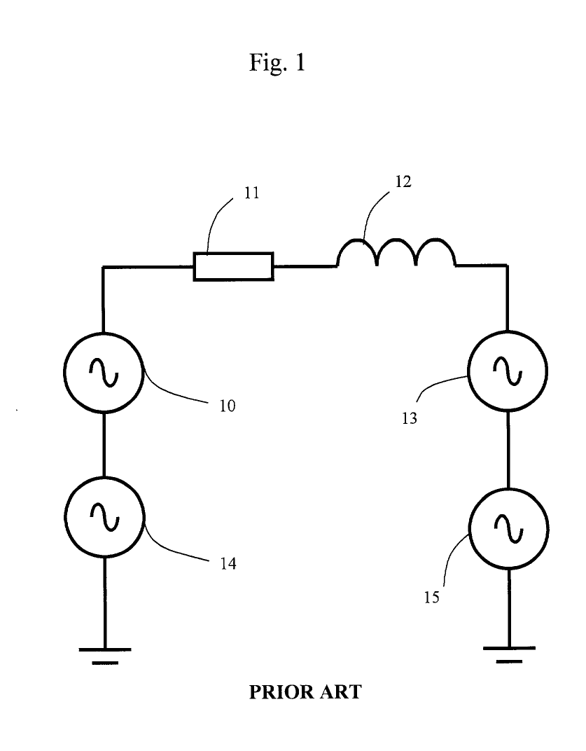

FIG. 1 presents the schematic block diagram depicting the electrical diagram of one of the phases of the typical embodiment of the prior art system. The voltage source 10 represents the fundamental component supplied by the power converter. Voltage source 14 represents low-level harmonics supplied by the power converter. Voltage source 13 represents the fundamental component of the back-EMF of the motor. Voltage source 15 represents harmonics of the back-EMF of the motor. The resistor 11 represents the resistance of the motor winding; inductor 12 represents the inductance of the motor winding. Sources 14 and 15 introduce undesirable harmonics that reduce the system efficiency. For the motoring and generating modes of operation, the amplitude and phase of the voltage sources 10 and 13 will differ, but the harmonics flow will not change. The high frequency components supplied by the power converter (e.g. results of the PWM switching) are not included for the simplicity of the presentation.

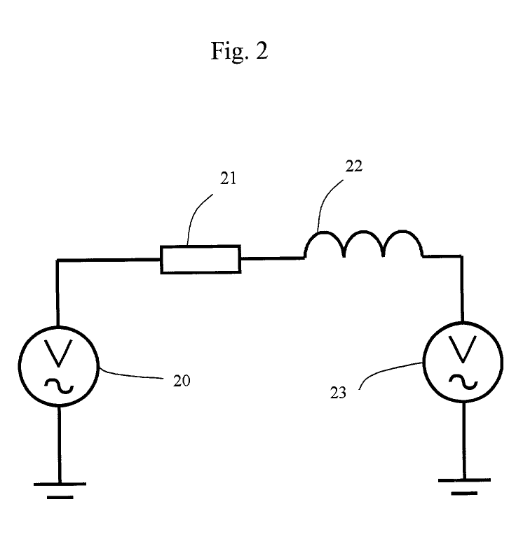

FIG. 2 presents the schematic block diagram depicting the electrical diagram in the typical embodiment of the disclosed invention. Voltage source 20 represents the voltage supplied by the power converter. Voltage source 23 represents the back-EMF of the machine. Resistor 11 represents the resistance of the machine winding; inductor 12 represents the inductance of the machine winding. The sources 20 and 23 represent voltages identical in shape (identical in the sense of normalized to the fundamental harmonics spectrums). The difference in phase and amplitude of sources 20 and 23 causes the machine winding current to flow. When the current is in phase with back-EMF, the converter-machine system achieves optimum efficiency. The current/back-EMF phase is controlled by changing the phase of the converter's voltage.

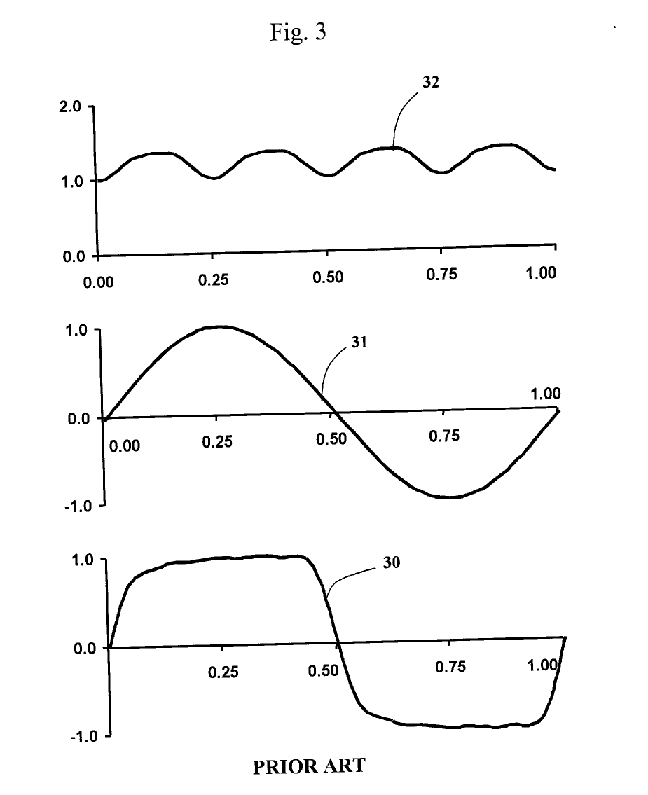

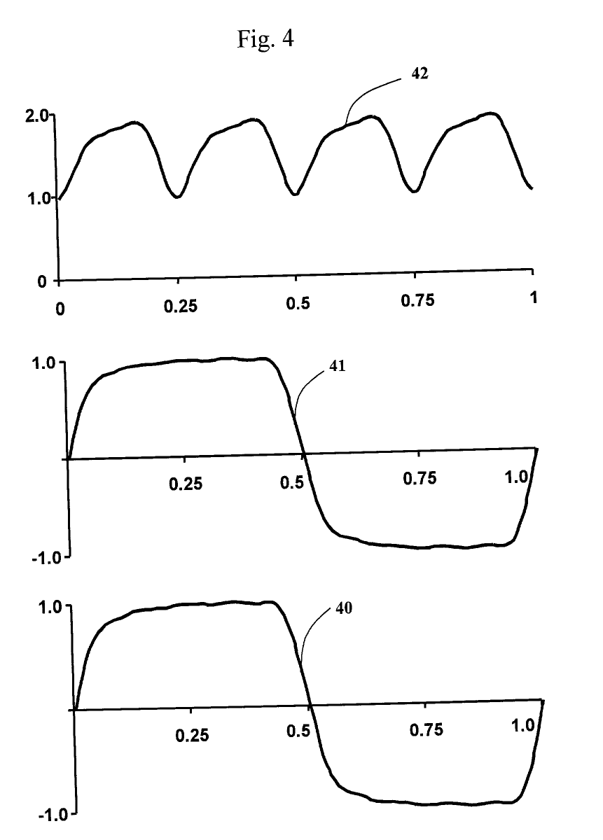

FIG. 3 and FIG. 4 present the waveforms in the systems operating with maximum efficiency. FIG. 3 presents the shape and phase relationship of the prior art sinusoidal current system employing a two phase permanent magnet synchronous machine. It presents the normalized machine's back-EMF 30, normalized sinusoidal current generated by the power converter 31, and normalized resulting torque 32. All waveforms are presented for a single shaft turn. FIG. 4 presents the shape and phase relationship of the system employing the disclosed invention to supply a two-phase permanent magnet synchronous machine. It presents the normalized machine's back-EMF 40, normalized current generated by the power converter 41, and normalized resulting torque 42. All waveforms are presented for a single shaft turn. The normalized machine current 41 and the normalized machine back-EMF 40 are identical in shape. The current 41 and the back-EMF 40 are in phase (no phase shift).

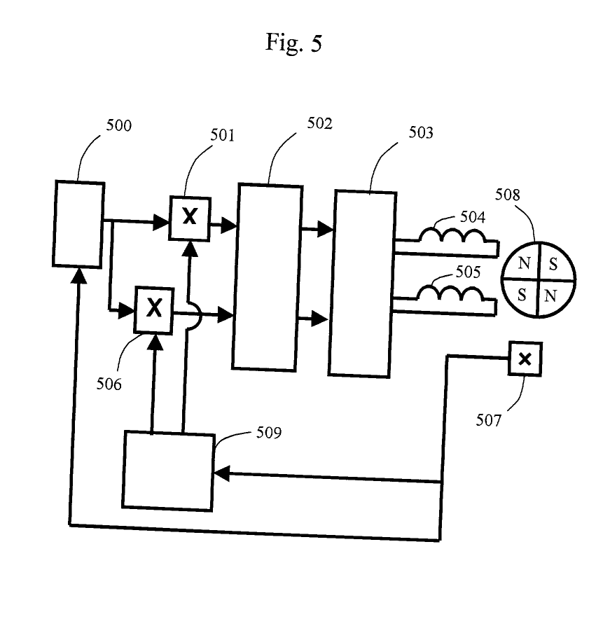

FIG. 5 presents the schematic block diagram depicting a two-phase embodiment of the disclosed invention. The blocks 500, 501, 506, and 509 form the controller of the system; block 502 represents PWM modulator; block 503 the power inverter; 504, 505, 508 the electrical machine and 507 the shaft position/speed sensor. The controller is implemented in the form of the algorithm in the DSP (Digital System Processor) based digital system. The block 500 represents the PID speed controller of the system. The blocks 501 and 506 symbolize the multiplying blocks. Based on the shaft position determined by shaft position sensor 507, the tabulated (discrete) or analytical (continuous) relationship between the shaft position/speed, and the shape of the back-EMF the block 509 generates two values representing the inverter voltage required for the current rotor position and speed. The block 509 compensates the phase shift between the back-EMF and machine current due to the presence of machine inductance. The relationships between the operating conditions (speed and position) and the back-EMF used by the block 509 are determined by the analysis of the electrical machine design (modeling), empirical measurements, or both methods. The signals controlling the PWM (Pulse Width Modulation) modulator 502 are created by multiplying the signals generated by the block 509 and the signals from the PID speed controller 500. The modulator 502 creates PWM (Pulse Width Modulated) pulses and supplies them to the two-phase inverter 503. The two full bridges (H bridges) feeding the windings of the motor 504 and 505 form the twophase voltage source inverter 503. The circle 508 represents the permanent magnet based rotor of the electric machine.

Due to the action of the controller, and more particularly the block 509, the power converter 503 introduces the current identical in shape and phase to the backEMF of the electrical machine. Consequently, the system efficiency becomes optimal, and the system reaches performance level of the more complicated and less cost-effective three-phase solutions.

Although the preferred embodiment of the invention presented in the FIG. 5 relates to the PWM (Pulse Width Modulation) based power converter, it is apparent to a person skilled in the art that the disclosed invention can be implemented by employing other power control techniques such as linear amplification or other types of power converters employing various types of modulation or control.

Even though the preferred embodiment of the invention presented in the FIG. 5 relates to the two phase system, it is apparent to a person skilled in the art that it can be employed in three and multi-phase systems.

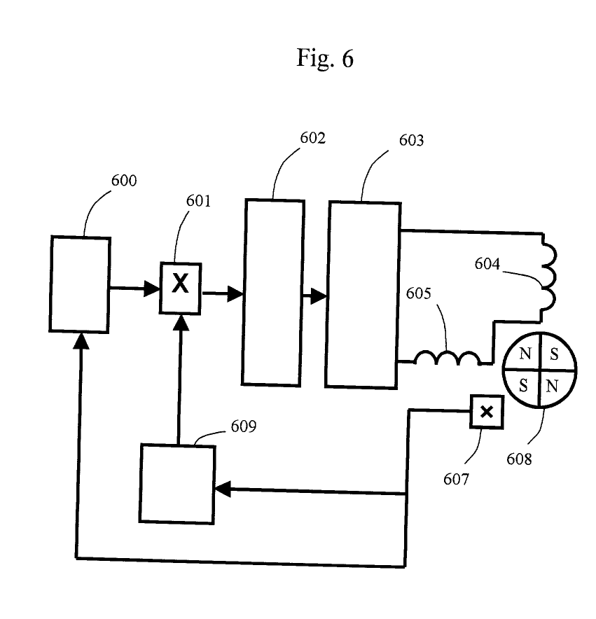

FIG. 6 presents the schematic block diagram depicting a single-phase embodiment of the disclosed invention. The blocks 600, 601, and 609 form the controller of the system; block 602 represents PWM modulator; block 603 the power inverter; 604, 605, 608 the two pole pair electrical machine with two windings generating two spatially perpendicular magnetic fields; and 507 the shaft position/speed sensor. The controller is implemented in the form of the algorithm in the DSP (Digital System Processor) based digital system. The block 600 represents a PID speed controller of the system. The block 601 represents the multiplying block. Based on the shaft position determined by the sensor 607 and the tabulated (discrete) or analytical (continuous) relationship between the operating conditions and the machine-generated harmonics the block 609 generates a value representing the inverter voltage required for the current rotor position and speed. The relationships between the operating conditions (speed and position) and the back-EMF used by the block 609 are determined by the analysis of the electrical machine design (modeling), empirical measurements, or both methods. The signal controlling the PWM (Pulse Width Modulation) modulator 602 is created by multiplying the signals generated by the block 609 and the signal from the PID speed controller 600. The modulator 602 creates the appropriate PWM pulses and supplies them to inverter 603. The voltage source inverter 603 is implemented by a full bridge (H bridge). The inverter feeds connected in series motor windings 604 and 605. The circle 608 represents the permanent magnet based, two pole pair rotor of the machine.

Due to the action of the controller, and more particularly the block 609, the power converter 603 introduces a current identical in shape and phase to the back-EMF of the electrical machine. Consequently, the system efficiency becomes optimal, and the system reaches the performance level of the more complicated and less cost-effective three-phase solutions.

Although the embodiment presented in the FIG. 6 supplies the windings of the two-phase motor connected in series, it is apparent to a person skilled in the art that depending on the motor configuration the windings can be connected in parallel or anti-parallel manner, or become virtually a single winding. Although the preferred embodiment of the invention presented in the FIG. 6 relates to the DSP (Digital System Processor) based digital controller, it is apparent to a person skilled in the art that the disclosed invention can be implemented by employing other control techniques such as analog, mixed digital-analog or discrete digital circuit technology.

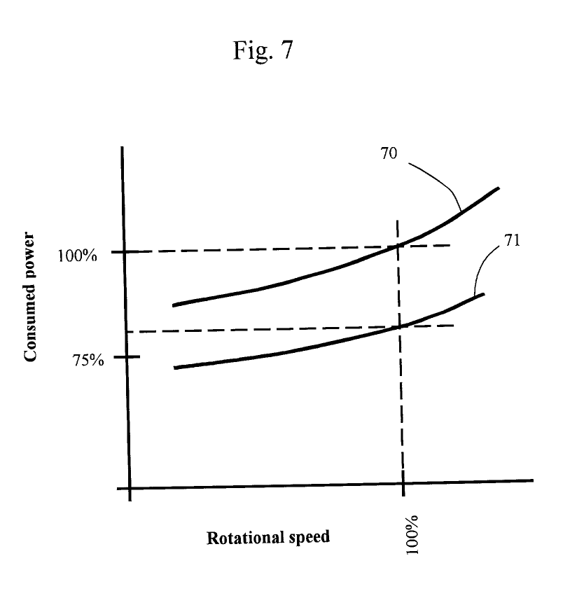

FIG. 7 presents the chart depicting the reduction of power consumption achieved by employing the disclosed method in the three-phase, four pole-pairs, and permanent magnet based, high-speed spindle of an enterprise class storage device (hard disc). Curve 70 presents the normalized power consumption of the system utilizing the prior art system as a function of rotational speed. Curve 71 presents the normalized power consumption as a function of rotational speed of the system utilizing the disclosed invention. Both curves are normalized to the power consumption of the prior art system at rated speed (100% =10 krpm). In both cases, the power consumption measurements were performed using the same three-phase inverter and the same three-phase, four pole-pair, permanent magnet based high-speed spindle. It is believed that the disclosed method accounts for approximately 50% of the efficiency improvement.

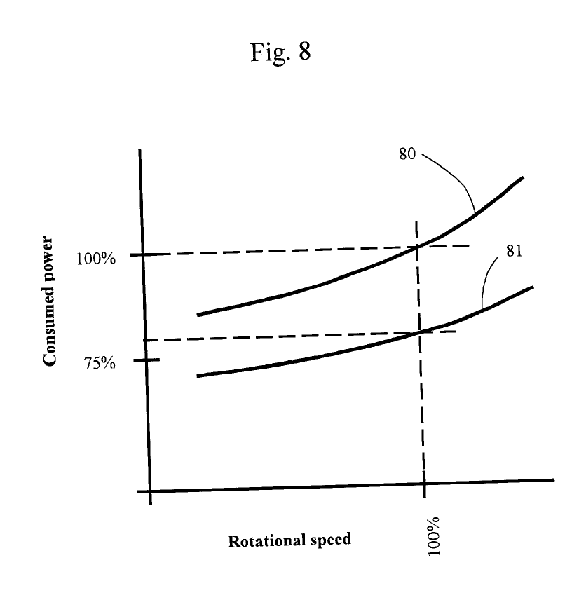

FIG. 8 presents the chart depicting the reduction of power consumption achieved by employing the disclosed method in the single-phase, two pole-pairs, permanent magnet based, motor employed in the DC brushless fan. Curve 80 presents the normalized power consumption of the system utilizing the prior art system as a function of rotational speed. Curve 81 presents the normalized power consumption as a function of rotational speed of the system utilizing the disclosed invention. Both curves are normalized to the power consumption of the prior art system at rated speed.

The method of maximizing the system efficiency in the system comprising of a synchronous electrical machine (motor or generator) and a power converter comprises of the following steps:

1. Characterization of the back-EMF of the electrical machine. This step may be performed during the design process (modeling), during each start-up sequence of the system, or during the operation of the system. The purpose of characterization is to create a tabulated (discrete) or analytical (continuous) relationship between the shaft position (angle) and the machine-induced voltage. This relationship represents the no-load voltage generated by the externally driven synchronous machine: back-EMF.

2. Introduction of the additional power converter generated harmonics to cause the flow of current with the shape identical (in sense of normalized harmonics spectrum) to the back-EMF of the machine. The current and the back-EMF are in phase (no phase shift); the ratio between the current and the back-EMF depends on the operating conditions and direction of the power flow (delivered or generated power). It is accomplished by employing a tabulated (discrete) or analytical (continuous) relationship between the shaft position (angle) and the machine-induced voltage established in Step 1 as a current reference and supplying it as a reference to the current controller. The current sensor or sensors are required for this method to be effective. By supplying the electrical machine with the current identical in shape (in the sense of normalized to the fundamental harmonics spectrum) and phase with the back-EMF, the point of maximum torque and maximum efficiency is reached. Another embodiment of the disclosed method of maximizing the system efficiency in the system comprising of a synchronous electrical machine (motor or generator) and a power converter as presented in FIG. 5 and FIG. 6 comprises of the following steps:

1. Characterization of the back-EMF of the electrical machine. This step may be performed during the design process (modeling), during each start-up sequence of the system, or during the operation of the system. The purpose of characterization is to create a tabulated (discrete) or analytical (continuous) relationship between the shaft position (angle) and the machine-induced voltage. This relationship represents the no-load voltage generated by the externally driven synchronous machine- back-EMF.

2. Introduction of the additional power converter generated harmonics to cause the flow of current with the shape identical (in sense of normalized harmonics spectrum) to the back-EMF of the machine. The current and the back-EMF are in phase (no phase shift); the ratio between the current and the back-EMF depends on the operating conditions and direction of the power flow (delivered or generated power). It is accomplished by employing a tabulated (discrete) or analytical (continuous) relationship between the shaft position (angle) and the machine-induced voltage established in Step 1 as a current reference.

3. Introduction of the additional power converter generated harmonics to cause the flow of current with the shape identical (in sense of the normalized harmonics spectrum) to the back-EMF of the machine of Step 2 may be also accomplished by supplying the machine with voltage identical in shape (in sense of the normalized harmonics spectrum) to the back-EMF of the machine. By keeping the converter voltage and the back-EMF appropriately shifted in phase (to compensate for caused by the machine inductance current/voltage phase shift) and controlling the ratio of the converter voltage to the back-EMF, the optimum of efficiency is achieved. For motoring, the inverter-generated voltage is larger than the back-EMF. For generating, the inverter-generated voltage is smaller than the back-EMF. Appropriately shifted in phase and identical in shape (in the sense of normalized to the fundamental harmonics spectrum) converter voltage and back-EMF cause also identical in shape (in the sense of normalized to the fundamental harmonics spectrum) current flow. By supplying the electrical machine with the current identical in shape (in the sense of normalized to the fundamental harmonics spectrum) and phase with the back-EMF, the point of maximum torque and maximum efficiency is reached.

I claim:

1. A method of improving the efficiency of the rotating electrical machine in a system comprising of a rotating electrical machine and a power converter comprising the steps of:
characterizing the back-EMF of the electrical machine;
controlling the machine current in such a way that the current shape is identical, in the sense of identical normalized to fundamental harmonics spectrums, to the shape of the machine back-EMF and the current and the back-EMF are in phase.

2. A method as claimed in claim 1 where characterization of the machine generated harmonics is achieved by creating the tabulated relationships among the machine speed, shaft position, and back-EMF of the machine.

3. A method as claimed in claim 1 where characterization of the machine generated harmonics is achieved by identifying the analytical relationships among the machine speed, shaft position, and back-EMF of the machine.

4. A method as claimed in claim 1 where characterization of the machine-generated harmonics is performed during start-up sequence of the system.

5. A method of improving the efficiency of the rotating electrical machine in a system comprising of a rotating electrical machine and a power converter comprising the steps of:
characterizing the back-EMF of the electrical machine;
generating the converter voltage identical, in the sense of identical normalized to fundamental harmonics spectrums, in shape to the back-EMF of the machine but shifted in phase in such a way that the back-EMF and the electrical machine currents are in phase.

6. A method as claimed in claim 5 where characterization of the machine generated harmonics is achieved by creating the tabulated relationships among the machine speed, shaft position, and back-EMF of the machine.

7. A method as claimed in claim 5 where characterization of the machine generated harmonics is achieved by identifying the analytical relationships among the machine speed, shaft position, and back-EMF of the machine.

8. A method as claimed in claim 5 where characterization of the machine-generated harmonics is performed during start-up sequence of the system.

9. A system comprising of a synchronous electrical machine and a power converter generating machine current of the shape identical, in the sense of identical normalized to fundamental harmonics spectrums, with the shape of the machine back-EMF and in phase with the back-EMF.

10. A system as claimed in claim 9 where the said power converter generates machine current of the shape identical with the shape of the machine back-EMF and in phase with the back-EMF by supplying voltage identical in shape with the back-EMF shifted in phase to compensate for phase shift introduced by the inductance of the machine.

11. A system as claimed in claim 9 where the said electrical machine is a permanent magnet synchronous machine.

12. A system as claimed in claim 9 where the said power converter generates two-phase voltages and the said electrical machine is a two-phase electrical machine.

13. A system as claimed in claim 9 where the said power converter generates single-phase voltage and the said electrical machine is a single-phase synchronous electrical machine.

14. A system as claimed in claim 9 where the said power converter generates two-phase voltages and the said electrical machine is a two-phase electrical machine.

15. A system as claimed in claim 9 where the said power converter generates multi-phase voltages and the said electrical machine is a multi-phase electrical machine.
